(19) United States
(12) Patent Application Publication
(10) Pub. No.: US 2012/0088454 A1
(43) Pub. Date: Apr. 12, 2012

(54) SYSTEM AND METHOD FOR POWER CONTROL IN PORTABLE ELECTRONIC DEVICES

(76) Inventors: Peter Stanforth, Winter Springs, FL (US); Hrishikesh Gossain, Heathrow, FL (US); Manish Shukla, Altamonte Springs, FL (US); Mario Camchong, Oviedo, FL (US)

(21) Appl. No.: 12/898,901

(22) Filed: Oct. 6, 2010

(51) Int. Cl. H04B 17/00; H04B 7/00

(52) U.S. Cl. 455/67.11

(57) ABSTRACT

Systems and methods for identifying and using a connectivity option that has lower power consumption in the electronic device than another, typically default, connectivity option. The mobile device may scan for connectivity options and communicate those options to a network access management system. The management system may, in turn, identify which option may reduce power consumption by the electronic device and communicate that option to the mobile device. It is contemplated that the mobile device may not have credentials for using the option that reduces power consumption by the electronic device. Therefore, access credentials may be supplied by the management system to enable the electronic device to use the option.

### TECHNICAL FIELD OF THE INVENTION

The technology of the present disclosure relates generally to portable electronic devices and, more particularly, to a system and method for controlling power consumption in the portable electronic devices.

### BACKGROUND

Mobile wireless electronic devices are becoming increasingly popular. But a challenge for these devices is reducing power consumption to extend battery charge. A large percentage of power consumption is attributable to the radio transceiver that is present to enable wireless communications.

### SUMMARY

To improve power management in mobile wireless electronic devices, the present disclosure describes systems and methods for identifying and using a connectivity option that has lower power consumption in the electronic device than another, typically default, connectivity option. The mobile device may scan for connectivity options and communicate those options to a network access management system. The management system may, in turn, identify which option may reduce power consumption by the electronic device and communicate that option to the mobile device. It is contemplated that the mobile device may not have credentials for using the option that reduces power consumption by the electronic device. Therefore, access credentials may be supplied by the management system to enable the electronic device to use the option.

According to one aspect of the disclosure, a method of managing power for a mobile electronic device includes ascertaining communications options for the mobile electronic device; analyzing the communications options to identify one of the communications options that, if used for wireless communications by the mobile electronic device, is predicted to have a lower power consumption by the mobile electronic device than use of another of the communications options; and selecting the identified communication option for wireless communications by the mobile electronic device.

According to another aspect of the disclosure, a network access management system for managing power for a mobile electronic device includes a communication interface over which communication with the mobile electronic device is made; and a processor configured to ascertain communications options for the mobile electronic device; analyze the communications options to identify one of the communications options that, if used for wireless communications by the mobile electronic device, is predicted to have a lower power consumption by the mobile electronic device than use of another of the communications options; and select the identified communication option for wireless communications by the mobile electronic device.

According to another aspect of the disclosure, a mobile electronic device includes a radio circuit assembly configured to carry out wireless communications with plural types of communications options; and a control circuit configured to: scan communications options for the mobile electronic device and transmit information regarding the communications options to a network access management system; receive a selection of one of the communications options from the network access management system, the selected communication option having a lower predicted power consumption by the mobile electronic device than for use of another of the communications options; and control the radio circuit assembly to carry out the wireless communications using the selected communication option.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

### BRIEF DESCRIPTION OF THE DRAWINGS

FIG. 1 is a schematic view of a communication system that includes a mobile electronic device and a network access management system;

FIG. 2 is a flow chart representing a first exemplary set of cooperative actions taken by the mobile electronic device and the network access management system to manage power consumption by the mobile electronic device; and

FIG. 3 is a flow chart representing a second exemplary set of cooperative actions taken by the mobile electronic device and the network access management system to manage power consumption by the mobile electronic device.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

In the present document, embodiments are described primarily in the context of a portable wireless radio communications device, such as the illustrated mobile electronic device. For purposes of description, the mobile electronic device may be a mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a personal digital assistant (PDA), an electronic book reader, etc.

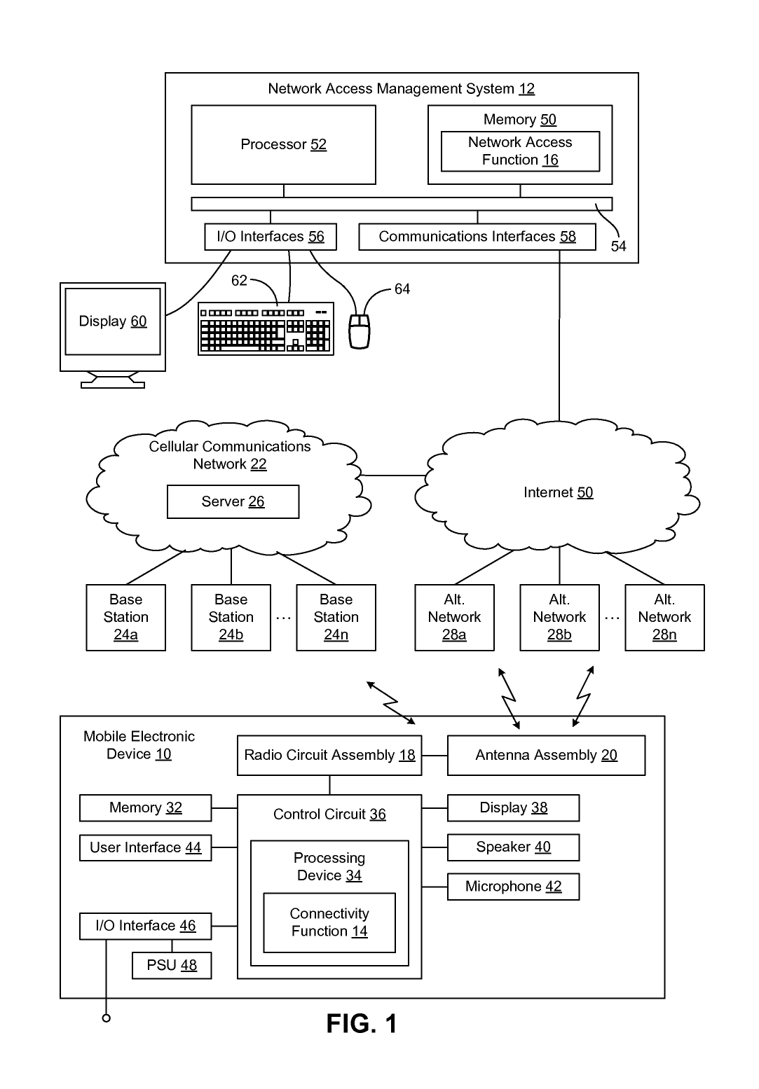

Referring initially to FIG. 1, shown is a system that includes an electronic device 10 and a network access management system 12. The electronic device 10 is portable and has wireless communication capabilities as will be described in greater detail below. The network access management system 12 may be configured as a server device that communicates with the electronic device 10 through one or more networks, as will also be described. The electronic device 10 may include a connectivity function 14 and the management system 12 may include a network access function 16. The connectivity function 14 and the network access function 16 may cooperate with each other to reduce power consumption in the electronic device 10 by enabling the electronic device 10 to carryout wireless communications using a connectivity option (e.g., network option) that uses less power than another connectivity option.

Each of the connectivity function 14 and the network access function 16 may be embodied as executable instructions (e.g., referred to in the art as code, programs, or software) that are respectively resident in and executed by the electronic device 10 and the network access management system 12. The functions 14 and 16 each may be one or more programs that are stored on respective non-transitory computer readable mediums, such as one or more memory devices (e.g., an electronic memory, a magnetic memory, or an optical memory). In the following description, an ordered logical flow for the functionality of the connectivity function 14 and network access function 16 is described. But it will be appreciated that the logical progression may be implemented in an object-oriented or a state-driven manner.

As indicated, the electronic device 10 may be configured to carry out wireless communications using plural connectivity options. For this purpose, the electronic device 10 may include communications circuitry in the form of a radio circuit assembly 18 and an antenna assembly 20. The radio circuit assembly 18 and the antenna assembly 20 represent circuitry to communicate over more than one type of communication interface. Therefore, the illustrated components represent one or more than one radio transceivers, depending on the capabilities of the implementing hardware to tune to multiple frequencies and carry out communications using multiple protocols.

For example, the electronic device 10 may be configured for interaction with a mobile telephone network in the form of a cellular communications network 22. Exemplary cellular communications networks 22 include, but are not limited to networks operating in accordance with global system for mobile communications (GSM), wideband code division multiple access (WCDMA), integrated services digital broadcasting (ISDB), high speed packet access (HSPA), or any other appropriate standard or advanced versions of these standards. The cellular communication network 22 may include communications base stations 24 (labeled in FIG. 1 as base stations 24a through 24n) that are strategically deployed to establish communications between the network 22 and the electronic device 10. The communications base stations 24 are typically in the form of cellular service towers, or “cell” towers. The network 22 may further include a server 26 (or servers) for supporting the communications activity of the electronic device 10 and other electronic devices 10, such as managing calls placed by and destined to the electronic device 10, transmitting data to and receiving data from the electronic device 10, and carrying out any other support functions. The electronic device 10 may subscribe to a communications plan offered by an operator of the communications network 22. The server 26 may be configured as a typical computer system used to carry out server functions and may include a processor configured to execute software containing logical instructions that embody the functions of the server 26 and a memory to store such software.

In one embodiment, the cellular communication network 22 may be a default communication option for the electronic device 10. But the electronic device 10 also may be configured to communicate with other types of networks, such as a packet-switched network. Each available alternative network 28 will be referred to as an alternative network 28 and each alternative network 28 may include one or more than one wireless access point or other communication interface through which communications with the electronic device 10 may be established. In the illustrated example, alternative networks 28 are labeled alternative networks 28a through 28n. It will be understood that in certain locations, no alternative networks 28 may be available, one alternative network 28 may be available, or more than one alternative network 28 may be available.

An exemplary alternative network 28 topology may be configured in accordance with IEEE 802.11a, IEEE 802.11b, or IEEE 802.11n, each of which are commonly referred to as WiFi. It will be appreciated that WiFi is not the only type of alternative network 28 to the cellular communications network 22. For example, a network in accordance with IEEE 802.16 (commonly referred to as WiMAX) may be available, or connectivity in accordance with Bluetooth may be available.

Another alternative network may be another cellular-switched communication network (not illustrated) that is operated by a different entity than the operator of the cellular communication network 22. In some situations, communicating with the other cellular-switched communication network may consume less power than communication with the cellular communications network 22 due to proximity of respective base-stations, interference, or other radio consideration.

It will be appreciated that the electronic device 10 may be capable of communicating using more than one standard and the illustrated radio circuit assembly 18 and antenna assembly 20 represent the hardware and functionality for each desired standard (e.g., there may be one or more than one radio transceiver and/or antenna as part of the electronic device 10).

The alternative networks 28 may allow the electronic device 10 to communicate with the Internet 50. An operative interface also may exist between the cellular communications network 22 and the Internet 50. Therefore, regardless of whether the radio circuit assembly 18 of the electronic device 10 establishes an operative communication link with the cellular communications network 22 or with the alternative network 28, the electronic device 10 may be able to carry out a full range of communication activities. These activities include, for example, communicating with the network access management system 12 or some other device (e.g., another portable electronic device). Other exemplary activities include, but are not limited to, calls, data transfers, and the like. Calls may take any suitable form such as, but not limited to, voice calls and video calls. The calls may be carried out over a cellular circuit-switched protocol of the cellular communication network 22 or may be in the form of a voice over Internet Protocol (VoIP) call that is established over a packet-switched capability of a cellular communication network 22 or over the alternative network 26. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in a memory 32, executing applications with a processing device 34 to allow user interaction with the data, displaying video and/or image content associated with the data, outputting audio sounds associated with the data, and so forth.

Overall functionality of the electronic device 10 may be controlled by a primary control circuit 36 that includes the processing device 34. The processing device 34 may execute code stored in a memory (not shown) within the control circuit 36 and/or in a separate memory (e.g., the memory 32) in order to carry out operation of the electronic device 10. For instance, the processing device 34 may be used to execute the connectivity function 14. The memory 32 may be, for example, one or more of a buffer, a flash memory, a hard drive, a removable media, a volatile memory, a non-volatile memory, a random access memory (RAM), or other suitable device. In a typical arrangement, the memory 32 may include a non-volatile memory for long term data storage and a volatile memory that functions as system memory for the control circuit 36. The memory 32 may exchange data with the control circuit 36 over a data bus. Accompanying control lines and an address bus between the memory 32 and the control circuit 36 also may be present.

Another component of the electronic device 10 may be a display 38 that is used to display visual information to a user. The electronic device 10 may include a speaker 40 and a microphone 42 to allow the user to carry out voice conversations. A user interface 44, such as a keypad and/or touch screen associated with the display 38, may be present to provide for a variety of user input operations.

The electronic device 10 may further include one or more input/output (I/O) interface(s) 46. The I/O interface(s) 46 may include one or more electrical connectors for connecting the electronic device 10 to another device (e.g., a computer) or an accessory (e.g., a personal handsfree (PHF) device) via a cable, and/or for connecting the electronic device 10 to a power supply. Therefore, operating power may be received over the I/O interface(s) 46 and power to charge a battery of a power supply unit (PSU) 48 within the electronic device 10 may be received over the I/O interface(s) 46. The PSU 48 may supply power to operate the electronic device 10 in the absence of an external power source. As will be appreciated, the amount of charge of the battery is related to the power consumed by components of the electronic device 10, and especially the radio circuit assembly 18. Therefore, battery operating time may be extended by decreasing power consumption by the radio circuit assembly 18.

The electronic device 10 also may include various other components. For instance, a camera (not shown) may be present for taking digital pictures and/or movies. Image and/or video files corresponding to the pictures and/or movies may be stored in the memory 32. A position data receiver (not shown), such as a global positioning system (GPS) receiver, may be involved in determining the location of the electronic device 10.

Turning now to the network access management system 12, the network access management system 12 may be implemented as a computer-based system that is capable of executing computer applications (e.g., software programs), including the network access function 16. The network access function 16, and any affiliated database information, may be stored on a computer readable medium, such as a memory 50. The memory may be a magnetic, optical or electronic storage device (e.g., hard disk, optical disk, flash memory, etc.), and may comprise several devices, including volatile and non-volatile memory components. Accordingly, the memory 50 may include, for example, random access memory (RAM) for acting as system memory, read-only memory (ROM), hard disks, optical disks (e.g., CDs and DVDs), tapes, flash devices and/or other memory components, plus associated drives, players and/or readers for the memory devices. To execute the network access function 16, the management system 12 may include one or more processors 52 used to execute instructions that carry out a specified logic routine(s). The processor 52 and the components of the memory 50 may be coupled using a local interface 54. The local interface 54 may be, for example, a data bus with accompanying control bus, a network, or other subsystem.

The management system 12 may have various video and input/output (I/O) interfaces 56 as well as one or more communications interfaces 58. The interfaces 56 may be used to operatively couple the management system 12 to various peripherals, such as a display 60, a keyboard 62, a mouse 64, etc. The communications interfaces 58 may include for example, a modem and/or a network interface card. The communications interfaces 58 may enable the system 12 to send and receive data signals, voice signals, video signals, and the like to and from other computing devices via an external network. In particular, the communications interfaces 58 may connect the management system 12 to the Internet 50.

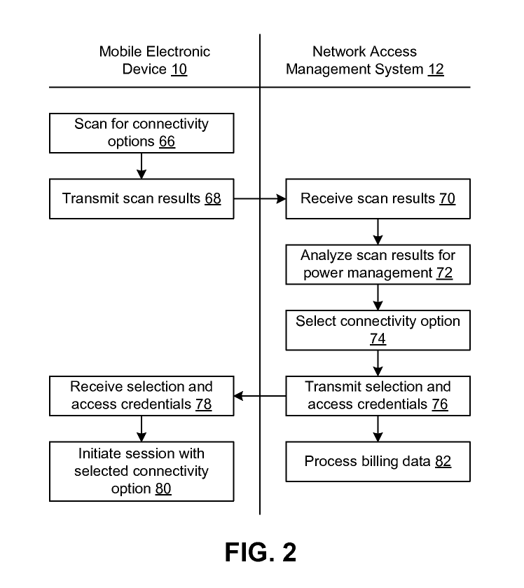

With additional reference to FIG. 2, illustrated are logical operations to implement an exemplary method of reducing power consumption by the electronic device 10. The exemplary method may be carried out by executing the connectivity function 14 and/or the network access function 16, for example. Thus, the flow chart of FIG. 2 may be thought of as depicting steps of a method carried out by the electronic device 10 and a method carried out by the management system 12. Although FIG. 2 shows a specific order of executing functional logic blocks, the order of executing the blocks may be changed relative to the order shown. Also, two or more blocks shown in succession may be executed concurrently or with partial concurrence. Certain blocks also may be omitted.

The logical flow may begin in block 66 where the electronic device 10 determines possible connectivity options to engage in wireless communications through the cellular communications network 22 and/or the Internet 50. The determination process may include scanning for the presence of alternative networks 28. Therefore, the communications options may include the default connection to the cellular communications network 22 or connection to one of the alternative networks 28.

If an alternative network 28 is found it is possible that the alternative network 28 may be directly accessible by the electronic device. For example, the electronic device 10 may be able to establish a session with the alternative network 28 without access credentials to join a secure network or pay for service. But user action may be required, such as action to accept terms of use for the alternative network 28. This situation will typically arise when the alternative network is an unsecure network, such as a network offered to patrons of a restaurant or coffee house. In other situations, the electronic device 10 may join a found alternative network 28 if the electronic device 10 has access credentials for the alternative network 28. This situation will typically arise when the alternative network 28 is a secure network, is available under a paid subscription and/or is available to predetermined categories of users.

Next, in block 68, the electronic device 10 may transmit the determined connectivity options to the network access management system 12. The connectivity option results may be received by the network access management system 12 in block 70.

In block 72, the management system 12 may analyze the connectivity options on behalf of the electronic device 10. Primarily, the results are analyzed to determine a prediction of how much power each connectivity option will consume by the electronic device 10. The power consumption for each option need not be quantified. Rather, a relative order of power consumption by type of connection may be established. For instance, cellular communication with the cellular communications network 22 may be considered to consume more power than communication with a WiFi network.

For purposes of the analysis, the electronic device 10 may provide additional information to the management system 12. For example, information to determine if the electronic device 10 is inside or outside may be provided. Cellular communications undertaken from inside a building typically involve the need for the corresponding signals to penetrate the building. Therefore, cellular communications that are carried out inside typically consume more power than cellular communications that are carried out outside.

Other information may include the type of communication activity that the electronic device 10 is engaged. For instance, it may be determined if the electronic device 10 is in a standby state, or is used or is predicted to be used for telephone calls, data transfers, messaging, and/or Internet browsing, as these activities may have different degrees of power consumption under the different types of connectivity options. The user also may desire these activities to have various degrees of performance. For example, a WiFi network may be able to deliver faster Internet access than the cellular communication network, but differences in data throughput for messaging may result in trivial differences in performance from the user perspective.

In addition to simply the identity of the communications options, the electronic device may collect and transmit performance metrics for each communication option to the management system 12. An exemplary performance metric may be received signal strength indicator (RSSI). Another exemplary performance metric may be an amount of network traffic or other indicator of potential interference. The performance metrics may be considered by the management system 12 since low communication performance could lead to needlessly high power consumption. Therefore, a determination of the lowest power consuming network need not be made on network type alone, but also on probable network performance.

Still other information that may be acquired for the analysis may be cost of service for each connectivity option. Assuming that the electronic device 10 subscribes to a service from the operator of the cellular communications network 22, this connectivity option may have no incremental increase in cost to communicate with the cellular communications network 22 through one of the base stations 24. One or more of the alternative networks 28 also may be free or incur no additional cost due to existing subscription status of the electronic device 10. But other alternative networks 28 may charge a fee for service. In one embodiment, the management system 12 may function as a clearinghouse for any additional fees. In one embodiment, a prearranged agreement may exist between an operator of the cellular communication network 22 and an operator of the alternative network 28 to handle fees for alternative network 28 usage by the electronic device 10. In other situations, an agreement may be in place between the operator of the management system 12 and the operator of the alternative network 28. It will be appreciated, however, that the fees and payment arrangements are not germane to the features of assisting the electronic device 10 lower power consumption.

Next, in block 74, the management system 12 selects one of the connectivity options for the electronic device 10 to use. The selection is primarily driven by which connectivity option will lower power consumption relative to the default connectivity option of the electronic device 10. Secondary considerations in selecting the connectivity option may include quality of service (QOS), throughput, cost for usage, latency, security, or any other pertinent consideration.

Once a determination as to which connectivity option to use is made, the logical flow may proceed to block 76. In block 76, the identity of the selection may be transmitted to the electronic device 10. Also, any access credentials to connect to the selected communication option may be communicated to the electronic device 10 in block 76. The access credentials may be, for example, a username and a password to log into a secure network formed by the selected communication option. The selection and any credentials may be received by the electronic device in block 78. Then, in block 80, the electronic device 10 may initiate communications using the selected communication option and, if needed, the access credentials that are received in block 78. Thereafter, the electronic device 10 may engage in various communications as described above, such by engaging in calls, Internet browsing, messaging, etc.

In block 82, the management system 12 may be further configured to process any billing or payment that results from the use of the selected communication option by the electronic device 10. As an example, it may be assumed that company ABC operates the cellular communications network 22 to provide cellular services to subscribers of ABC's service and that company XYZ operates one of the alternative networks 28 to provide WiFi services to subscribers of XYZ's service. ABC and XYZ may have an arrangement that allows the management system 12 to provide ABC's subscribers with access credentials to XYZ's alternative network 28. There may be a predetermined fee arrangement between ABC and XYZ based on usage by ABC's subscribers. To support this arrangement, the management system 12 may create a billing record each time one of ABC's subscribers is provided access credentials to XYZ's network.

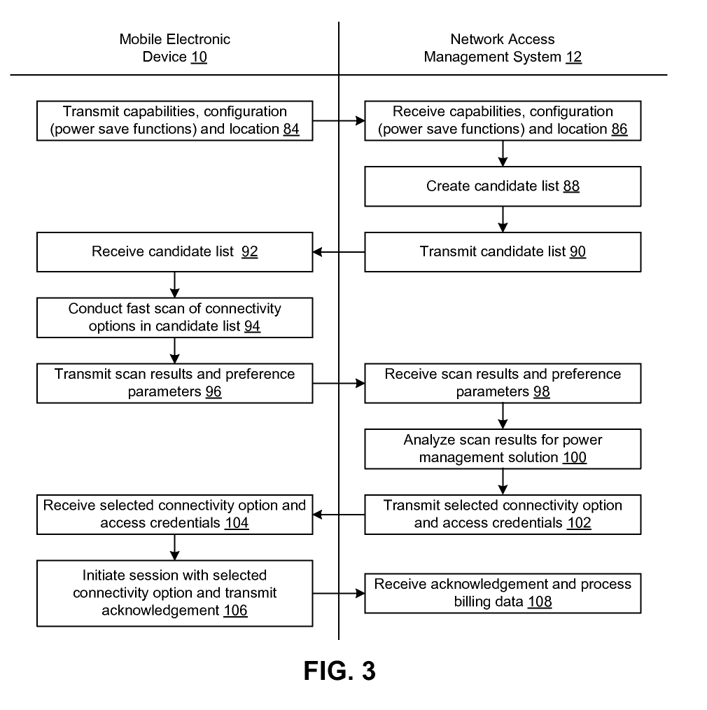

With additional reference to FIG. 3, illustrated are logical operations to implement another exemplary method of reducing power consumption by the electronic device 10. The exemplary method may be carried out by executing the connectivity function 14 and/or the network access function 16, for example. Thus, the flow chart of FIG. 3 may be thought of as depicting steps of a method carried out by the electronic device 10 and a method carried out by the management system 12. Although FIG. 3 shows a specific order of executing functional logic blocks, the order of executing the blocks may be changed relative to the order shown. Also, two or more blocks shown in succession may be executed concurrently or with partial concurrence. Certain blocks also may be omitted. In addition, some of the operations illustrated and described with respect to FIG. 3 may be supplemented and/or replaced by operations illustrated and described with respect to FIG. 2. Therefore, aspects from the two logical flows may be combined to form alternative approaches to power management for the electronic device 10.

The logical flow may begin in block 84 where the electronic device 10 transmits information to the management system 12. The information may be received by the management system 12 in block 86. The information may include capabilities of the electronic 10, power save capabilities/configurations of the electronic device 10, and a location of the electronic device 10. The capabilities may include protocols and types of network interfaces supported, frequencies supported and any other information that may be used by the management system 12 to ascertain whether the electronic device 10 is compatible with alternative networks 28 known to operate in the location of the electronic device 10, including individual base stations or access points within those networks 28. The power save capabilities of the electronic device 10 may include each power save protocol that is supported by the electronic device 10 for each type of network interface that is supported by the electronic device 10. For example, a WiFi capable device may also support advance power save options, such as IEEE 802.11n power save multi-poll.

In block 88, the management system 12 may create a list of candidate alternative networks 28 that are operative in the location of the electronic device 10. The list may include specific base stations or access points within the alternative networks 28. The members of the candidate list are selected to reduce scanning overhead in the electronic device 10. For instance, the candidate list may be configured to provide sufficient information to the electronic device 10 so that the electronic device may only scan channels for which the electronic device 10 should expect to find an alternative network with which the electronic device 10 may associate. The candidate list may include capability and configuration information regarding each alternative network 28 and/or each base station or access point in the candidate list. In block 90, the candidate list may be transmitted to the electronic device 10 and the electronic device 10 may receive the candidate list in block 92.

In block 94, the electronic device 10 may perform a “fast scan” for available connectivity options. The scan of block 94 may include scanning channels corresponding to the alternative networks 28 (or specific base stations or access points) contained in the candidate list received in block 92. In this manner, the electronic device 10 avoids scanning all possible channels and under all supported communications protocols. Rather, the electronic device 10 scans a subset of the possible channels and supported communications protocols, focusing on channels on which the electronic device 10 should encounter a possible communication option. The scan may collect data concerning each item in the candidate list, including signal strength (e.g., RSSI).

In block 96, the electronic device 10 may transmit the scan results to the management system 12. The scan results may be received by the management system in block 98. The scan results may include the identity of alternative networks 28 (including, in one embodiment, specific base stations or access points) that were found during the scan and collected signal strength information, as well as any other information collected during the scan. The transmission of block 96 also may include preference parameters, or parameters that the management system 12 may use to select an individual network 22 or 28 that the electronic device 10 may use to conserve power. The preference parameters may include a preferred power save protocol of the electronic device 10, a traffic profile, an application type (e.g., voice communications, general Internet connectivity, etc.), security requirements, and so forth.

In block 100, the management system 12 may analyze the information that is received in block 98 to establish a power management solution for the electronic device 10. The analysis may consider one or more factors such as, but not limited to, the scan results, the preference parameters, the application requirements of the electronic device 10 (e.g., in terms of minimum expected throughput and/or quality of service), location of the electronic device 10, power save capabilities of both the electronic device 10 and the candidate networks, security, cost of use, and effective isotropic radiated power (EIRP). The power management solution may be an identification of a specific network (e.g., the network 22 or one of the alternative networks 28) that is selected by the management system 12 to provide communications services and effective power management for the electronic device 10 (e.g., minimize or reduce power consumption). In some embodiments, the power management solution may further include a specific base station 24 or a specific wireless access point of an alternative network 28 that the electronic device 10 should employ.

The selected connectivity option and any access credentials that may be needed for the electronic device 10 to establish a session with the selected connectivity option may be transmitted to the electronic device 10 in block 102. This information may be received by the electronic device 10 in block 104. In block 106, the electronic device 10 may initiate a session with the connectivity option that is received in block 104. When the session is established, the electronic 10 may transmit an acknowledgement that the session has been established to the management system 12. The management system 12 may receive the acknowledgement in block 108 and process any billing data as described above in connection with block 82.

The described techniques for power management may be implemented to provide communication coverage over a wide area, as well as to support mobility of the electronic device. Typically power management is carried out internally by the electronic device 10 to reduce power consumption of idle components and is carried out by the network with which the electronic device communicates to reduce interference. While these techniques are still relevant, the described techniques add a more comprehensive approach to power management. In one exemplary situation, a traveler may wish to use a mobile electronic device in an airport. In the location of the airport interference from other radios systems and the construction of the terminal may lead to increased power consumption when communicating with the cellular communication network with which the electronic device has a subscription. The airport may have one or more WiFi networks that, if used by the electronic device, would reduce power consumption. But those alternative communication options may require access credentials and/or fee payment. The disclosed technique may provide the electronic device with access credentials. In one approach, an agreement may exist that allows subscribers of the cellular communication network to use the alternative network and payment for such use, if applicable, may be managed by the management system 12 in a manner that is transparent to the user of the electronic device 10. In one further approach, if charges are to be passed to the user by the user's cellular service provider, the user may be requested to approve the charges and the charges may appear on the user's next bill.

An advantage of the disclosed techniques is that the disclosed techniques may have high reliability due to the availability of the wide area network (e.g., the cellular communication network), but reduce power when the electronic device is in the location of other types of networks. Typically, these other types of networks will have a smaller footprint than the cellular communication network. Thus, the availability of the alternative network is less deterministic. Even still, the presence of the alternative networks may be known and/or sensed and, if possible, employed for wireless communications. The management system may be configured to provide the electronic device with control mechanisms to make previously unusable or difficult to use connectivity options available for exploitation. In addition, the management system may function as a repository for access credentials and as a clearing house for billing and payment, thereby increasing ease of use for the user of the electronic device.

Although certain embodiments have been shown and described, it is understood that equivalents and modifications falling within the scope of the appended claims will occur to others who are skilled in the art upon the reading and understanding of this specification.

What is claimed is:

1. A method of managing power for a mobile electronic device, comprising:
ascertaining communications options for the mobile electronic device;
analyzing the communications options to identify one of the communications options that, if used for wireless communications by the mobile electronic device, is predicted to have a lower power consumption by the mobile electronic device than use of another of the communications options; and
selecting the identified communication option for wireless communications by the mobile electronic device.

2. The method of claim 1, wherein the analyzing includes evaluating network type for each communication option.

3. The method of claim 2, wherein the analyzing, for each communication option, further includes evaluating at least one of a performance metric, location of the mobile electronic device, security, or performance.

4. The method of claim 2, wherein the analyzing, for each communication option, further includes evaluating cost of use.

5. The method of claim 1, wherein the communication options include a default communications option in the form of a cellular communications network and at least one alternative network.

6. The method of claim 5, wherein the alternative network is a network compatible with IEEE 802.11.

7. The method of claim 1, further comprising creating a billing record for use of the selected communication option by the mobile electronic device.

8. The method of claim 1, wherein the ascertaining, analyzing and selecting steps are carried out by the mobile electronic device.

9. The method of claim 1, wherein the ascertaining, analyzing and selecting steps are carried out by a network access management system.

10. The method of claim 9, wherein the ascertaining step includes receiving information regarding the communications options from the mobile electronic device.

11. The method of claim 9, wherein the ascertaining step includes determining the communications options by matching a location of the electronic device to known compatible network operation information that is stored in a database that is access by the network access management system.

12. The method of claim 9, further comprising transmitting the ascertained communications options to the electronic device and receiving back scan results made by the electronic device of the channels associated with the communications options, and the analyzing including use of the scan results to make the identification of the one of the communications options.

13. The method of claim 1, further comprising providing access credentials for the selected communications option to the mobile electronic device.

14. The method of claim 13, wherein the access credentials are a user name and a password.

15. A network access management system for managing power for a mobile electronic device, comprising:
a communication interface over which communication with the mobile electronic device is made; and
a processor configured to:
ascertain communications options for the mobile electronic device;
analyze the communications options to identify one of the communications options that, if used for wireless communications by the mobile electronic device, is predicted to have a lower power consumption by the mobile electronic device than use of another of the communications options; and
select the identified communication option for wireless communications by the mobile electronic device.

16. The management system of claim 15, wherein the analysis includes evaluating network type for each communication option.

17. The management system of claim 16, wherein the analysis, for each communication option, further includes evaluating at least one of a performance metric, location of the mobile electronic device, security, or performance.

18. The management system of claim 16, wherein the analyzing, for each communication option, further includes evaluating cost of use.

19. The management system of claim 15, wherein the communication options include a default communications option in the form of a cellular communications network and at least one alternative network.

20. The management system of claim 19, wherein the alternative network is a network compatible with IEEE 802.11.

21. The management system of claim 15, wherein the management system provides access credentials for the selected communications option to the mobile electronic device.

22. A mobile electronic device, comprising:
a radio circuit assembly configured to carry out wireless communications with plural types of communications options; and
a control circuit configured to:
scan communications options for the mobile electronic device and transmit information regarding the communications options to a network access management system;
receive a selection of one of the communications options from the network access management system, the selected communication option having a lower predicted power consumption by the mobile electronic device than for use of another of the communications options; and
control the radio circuit assembly to carry out the wireless communications using the selected communication option.
